(19) United States
(12) Patent Application Publication
(10) Pub. No.: US 2011/0115220 A1
(43) Pub. Date: May 19, 2011

(54) Tube coupling device

(76) Inventor: Kuang Ming Kuo, Taipei Hsien (TW)

(21) Appl. No.: 12/592,086

(22) Filed: Nov. 19, 2009

(51) Int. Cl. F16L 19/04

(52) U.S. Cl. 285/353

(57) ABSTRACT

A tube coupling device includes a lock nut having a peripheral flange, an adapter having a peripheral rib for engaging with the peripheral flange, a male element having an outer thread threaded to the lock nut, and a washer disposed between the adapter and the male element and to be compressed between the adapter and the male element, and the washer includes a cylindrical member for engaging into the bore of the adapter and for contacting an inner peripheral portion of the adapter, and for preventing the adapter and the male element from being rusted, and for preventing the heavy metal or other poisonous materials from being released from the adapter and the male element.

### BACKGROUND OF THE INVENTION

1. Field of the Invention

The present invention relates to a tube coupling device, and more particularly to a tube coupling device including an improved washer or insulator sleeve for suitably coupling two heavy-walled tubular members together and for making a suitable water seal between the heavy-walled tubular members.

2. Description of the Prior Art

Typical tube or conduit coupling devices comprise two tubular members and two or more compression fittings or lock nuts and one or more sealing rings or gaskets engaged between the tubular members for coupling and securing the tubular members together and for making a suitable water seal between the heavy-walled tubular members.

For example, U.S. Pat. No. 3,468,566 to Nietzel discloses one of the typical conduit couplings comprising an externally tapering, internally shouldered and deformable ferrule and internally tapering, relatively harder and mutually joinable compression and adapter fittings for gripping the ferrule between tubular members.

However, the ferrule is normally and simply fitted between the tubular members, but may not be engaged into the tubular members for contacting and shielding or protecting the coupling portions of the tubular members.

U.S. Pat. No. 4,037,864 to Anderson et al. discloses another typical pipe coupling related to a compression joint of the type used to connect the end of a piece of compressible pipe to a corporation fitting such as a curb stop, a main stop or a ball valve, and the pipe is usually soft copper and the wall of which is compressible or deformable.

However, the compressible washers or gaskets are disposed or fitted on the outer portion of the pipe or tubular member, but may not be engaged into the pipe or tubular member for contacting and shielding or protecting the coupling portion of the pipe or tubular members.

U.S. Pat. No. 4,915,427 to Zahuranec, U.S. Pat. No. 5,351,998 to Behrens et al., U.S. Pat. No. 5,934,714 to Sugiyama et al., and U.S. Pat. No. 6,345,845 to Johnston disclose four further typical phase controlled sequential gripping tube fittings for gripping a tube therein.

However, similarly, the compressible gaskets or compressible rings are disposed or fitted on the outer portion of the pipe or tubular member, but may not be engaged into the pipe or tubular member for contacting and shielding or protecting the coupling portion of the pipe or tubular members.

The present invention has arisen to mitigate and/or obviate the afore-described disadvantages of the conventional tube coupling devices.

### SUMMARY OF THE INVENTION

The primary objective of the present invention is to provide a tube coupling device including an improved washer or insulator sleeve for suitably coupling two heavy-walled tubular members together and for making a suitable water seal between the heavy-walled tubular members.

In accordance with one aspect of the invention, there is provided a tube coupling device comprising a lock nut including an inner thread formed therein, and including a peripheral flange extended radially and inwardly therefrom for forming an opening in the peripheral flange of the lock nut, an adapter engaged through the opening of the peripheral flange of the lock nut and including a peripheral rib extended radially and inwardly therefrom for engaging with the peripheral flange of the lock nut and for anchoring the adapter to the lock nut, a male element including an outer thread formed thereon for engaging with the inner thread of the lock nut and for engaging with the adapter and for anchoring and positioning the adapter and the male element together, and a washer disposed between the adapter and the male elements and to be compressed and retained between the adapter and the male elements and including a cylindrical member for engaging into a bore of the adapter and for contacting an inner peripheral portion of the adapter and for maintaining and determining the water flowing quantity through the adapter.

An insulator sleeve may further be provided and includes an outer peripheral lip extended radially and inwardly therefrom for forming a peripheral shoulder and for engaging with the peripheral flange of the lock nut, and the outer peripheral lip of the insulator sleeve is to be compressed and retained or secured between the peripheral rib of the adapter and the peripheral flange of the lock nut.

The insulator sleeve includes an outer peripheral fence extended upwardly from the outer peripheral lip for engaging with the peripheral rib of the adapter and for further anchoring or positioning the insulator sleeve between the adapter and the lock nut.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a tube coupling device in accordance with the present invention;

FIG. 2 is a cross sectional view of the tube coupling device; and

FIG. 3 is a cross sectional view similar to FIG. 2, illustrating the other arrangement of the tube coupling device.

### DETAILED DESCRIPTION OF THE PREFERRED EMBODIMENT

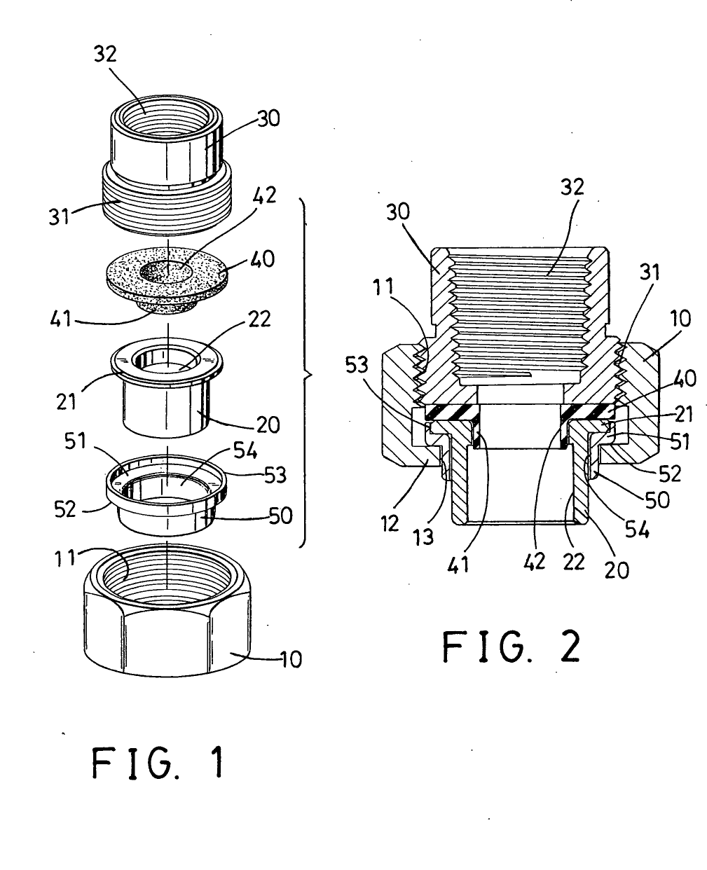

Referring to the drawings, and initially to FIGS. 1 and 2, a tube coupling device in accordance with the present invention comprises a lock nut 10 including a screw hole or inner thread 11 formed therein, and including a peripheral flange 12 extended radially and inwardly therefrom (FIG. 2) for forming or defining an opening 13 in the peripheral flange 12 of the lock nut 10, an adapter 20 is engaged through the opening 13 of the peripheral flange 12 of the lock nut 10 and includes a peripheral rib 21 extended radially and inwardly therefrom for engaging with the peripheral flange 12 of the lock nut 10 and for stably anchoring or positioning or mounting the adapter 20 to the lock nut 10.

A male element 30 includes an outer thread 31 formed thereon for threading or engaging with the screw hole or inner thread 11 of the lock nut 10 and for engaging with the adapter 20, and thus for stably or solidly anchoring or positioning or mounting or coupling the adapter 20 and the male element 30 together, and for solidly attaching or mounting or securing the adapter 20 and the male element 30 to the lock nut 10. The male element 30 includes a screw hole or inner thread 32 formed therein for threading or engaging with or coupling to the other pipes or hoses (not shown) and for allowing the water to flow from the adapter 20 toward and through the male element 30.

A washer 40 is disposed between and engaged with the adapter 20 and the male element 30, and is made of soft or resilient or compressible materials to be compressed and retained between the adapter 20 and the male element 30, and includes a cylindrical member 41 formed and provided in the radial and inward portion thereof for forming or defining a compartment 42 therein and for engaging into a bore 22 of the adapter 20, and for contacting and shielding or protecting the inner peripheral portion of the adapter 20, and for maintaining and determining the water flowing quantity through the adapter 20.

An insulator sleeve 50 may further be provided and disposed or engaged between the adapter 20 and the lock nut 10. For example, the insulator sleeve 50 includes an outer peripheral lip 51 extended radially and outwardly therefrom for forming or defining a peripheral shoulder 52 and for engaging with the peripheral flange 12 of the lock nut 10, the outer peripheral lip 51 of the insulator sleeve 50 is to be compressed and retained between the peripheral rib 21 of the adapter 20 and the peripheral flange 12 of the lock nut 10, and the insulator sleeve, 50 includes an outer peripheral fence 53 extended upwardly from the outer peripheral portion of the outer peripheral lip 51 for engaging with the peripheral rib 21 of the adapter 20 and for further stably or solidly anchoring or positioning or mounting or securing the insulator sleeve 50 between the adapter 20 and the lock nut 10, and the insulator sleeve 50 includes a chamber 54 formed therein for receiving or engaging with or attaching or supporting the adapter 20.

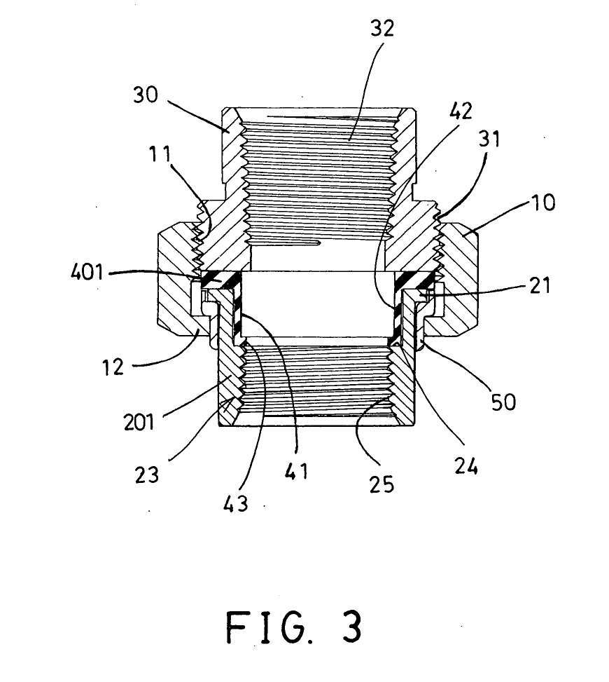

Alternatively, as shown in FIG. 3, the adapter 201 may further include a peripheral protrusion 23 extended radially and inwardly therefrom for forming or defining an inner peripheral shoulder 24 therein, and includes a screw hole or inner thread 25 formed therein for threading or coupling to the other pipes or hoses (not shown). The washer 401 further includes an inner peripheral projection 43 extended radially and inwardly therefrom for engaging with the inner peripheral shoulder 24 of the adapter 201 and for further stably or solidly anchoring or positioning or mounting or securing the washer 401 to the adapter 201.

In operation, as shown in FIG. 2, the cylindrical member 41 of the washer 40 may be provided and engaged into the bore 22 of the adapter 20 for contacting and shielding or protecting the inner peripheral portion of the adapter 20, and for maintaining and determining the water flowing quantity through the adapter 20. It is to be noted that a potential difference may be generated between the coupling portions of the adapter 20 and the male element 30, and the provision and the engagement of the cylindrical member 41 of the washer 40 into the bore 22 of the adapter 20 may prevent the coupling portions of the adapter 20 and the male element 30 from being rusted, and may further prevent the heavy metal materials or other poisonous materials from being rushed or released or disengaged from the adapter 20 and the male element 30 and from entering into the adapter 20 and the male element 30.

Accordingly, the tube coupling device in accordance with the present invention includes an improved washer or insulator sleeve for suitably coupling two heavy-walled tubular members together and for making a suitable water seal between the heavy-walled tubular members.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tube coupling device comprising:
a lock nut including an inner thread formed therein, and including a peripheral flange extended radially and inwardly therefrom for forming an opening in said peripheral flange of said lock nut,
an adapter engaged through said opening of said peripheral flange of said lock nut and including a peripheral rib extended radially and inwardly therefrom for engaging with said peripheral flange of said lock nut and for anchoring said adapter to said lock nut,
a male element including an outer thread formed thereon for engaging with said inner thread of said lock nut and for engaging with said adapter and for anchoring and positioning said adapter and said male element together, and
a washer disposed between said adapter and male element and to be compressed and retained between said adapter and male element and including a cylindrical member for engaging into a bore of said adapter and for contacting an inner peripheral portion of said adapter.

2. The tube coupling device as claimed in claim 1 further comprising an insulator sleeve including an outer peripheral lip extended radially and inwardly therefrom for forming a peripheral shoulder and for engaging with said peripheral flange of said lock nut, and said outer peripheral lip of said insulator sleeve is to be compressed and retained between said peripheral rib of said adapter and said peripheral flange of said lock nut.

3. The tube coupling device as claimed in claim 2, wherein said insulator sleeve includes an outer peripheral fence extended upwardly from said outer peripheral lip for engaging with said peripheral rib of said adapter and for anchoring said insulator sleeve between said adapter and said lock nut.
